(19) United States
(12) Patent Application Publication
(10) Pub. No.: US 2008/0175642 A1
(43) Pub. Date: Jul. 24, 2008

(54) Check processing and deposit ticket printing system

(76) Inventor: Yekusiel Teitelbaum, Brooklyn, NY (US)

Correspondence Address: JAMES RAY & ASSOCIATES, 2640 PITCAIRN ROAD, MONROEVILLE, PA, 15146, US

(21) Appl. No.: 12/004,795

(22) Filed: Dec. 21, 2007

Related U.S. Application Data
(60) Provisional application No. 60/871,159, filed on Dec. 21, 2006.
(60) Provisional application No. 60/871,160, filed on Dec. 21, 2006.
(60) Provisional application No. 60/871,164, filed on Dec. 21, 2006.

(51) Int. Cl. B41J 5/30

(52) U.S. Cl. 400/73

(57) ABSTRACT

A check processing and deposit ticket printing system which in which checks are scanned and the check information is captured. The check information is received by a first processor to calculate a deposit total and item count. The check information, deposit balance and item count is displayed. The user validates the data or corrects the information using and input device. User issues a print command to the first processor and the validated data received by a second processor to format the data and is received by a printer to print the check information, deposit total and subtotals and item counts on deposit tickets.

### CROSS REFERENCE TO RELATED APPLICATION

This patent application is related to and claims priority from U.S. Provisional Patent Application Ser. No. 60/871,159 filed Dec. 21, 2006, U.S. Provisional Patent Application Ser. No. 60/871,160 filed Dec. 21, 2006 and U.S. Provisional Patent Application Ser. No. 60/871,164 filed Dec. 21, 2006.

### FIELD OF THE INVENTION

The present invention relates, in general, to financial document processing and, more particularly, this invention relates to check processing and deposit ticket printing.

### BACKGROUND OF THE INVENTION

Prior to the conception and development of the present invention, as is generally well known in the prior art, dedicated check reader and dedicated receipt printers are well known. There are processing systems that capture check information. However, the prior art does not provide an apparatus capable of capturing check information and printing deposit tickets in a conventional format.

### SUMMARY OF THE INVENTION

The present invention provides a system for batch processing of checks through a scanner to capture the bank and check amount information. A processor calculates the deposit balance and item count. The calculated balance, check information and item count is displayed for the user. The user can correct the information manually. After the information is correct, a command is issued preferably by engaging a dedicated button. A processor formats the check information, deposit balance and item amount. The formatted check information, deposit balance and item count is printed on conventionally formatted deposit tickets

### OBJECTS OF THE INVENTION

It is, therefore, one of the primary objects of the present invention to provide a system to capture check information with a scanner for optical and magnetic ink.

Another object of the present invention is to provide a display of captured information and the calculated deposit balance and item count.

Still another object of the present invention is to provide a system to correct any information

Yet another object of the present invention is to provide a system to print conventionally formatted deposit ticket.

An additional object of the present invention is to provide a convenient holder for deposit tickets.

A further object of the present invention is to have the processing and printing in a single apparatus.

Another object of the present information is to provide the processing and control of the process on a personal computer.

A further object is to provide a system in which the information is manually entered and printed in a single apparatus.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a perspective view of the single apparatus embodiment.

FIG. 2 is a flow chart of the system.

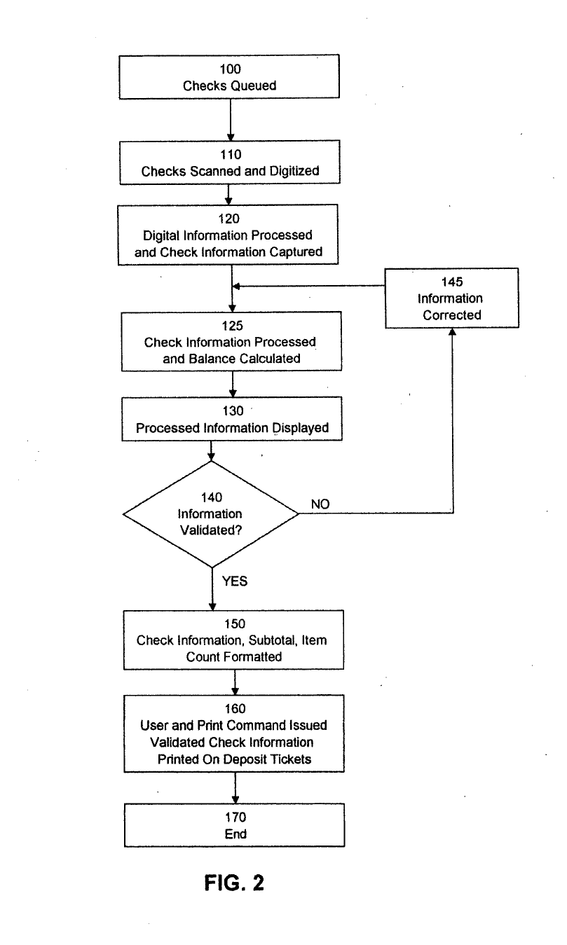

FIG. 3 is a perspective view of a manual data entry system and deposit ticker.

FIG. 4 is a perspective view of paper holder.

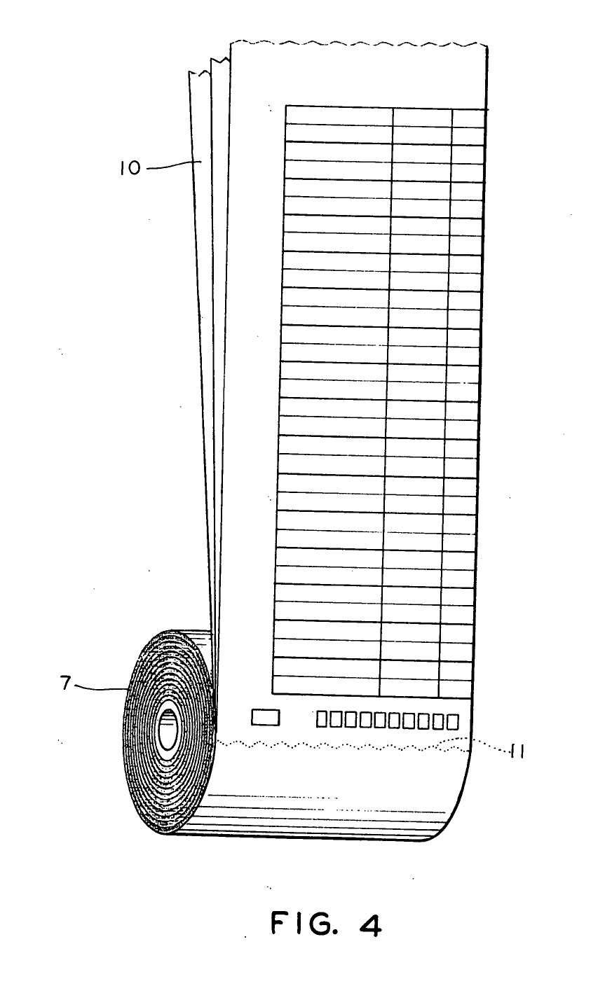

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components that have identical functions have been identified with identical reference numerals throughout the several views illustrated in the drawing figures.

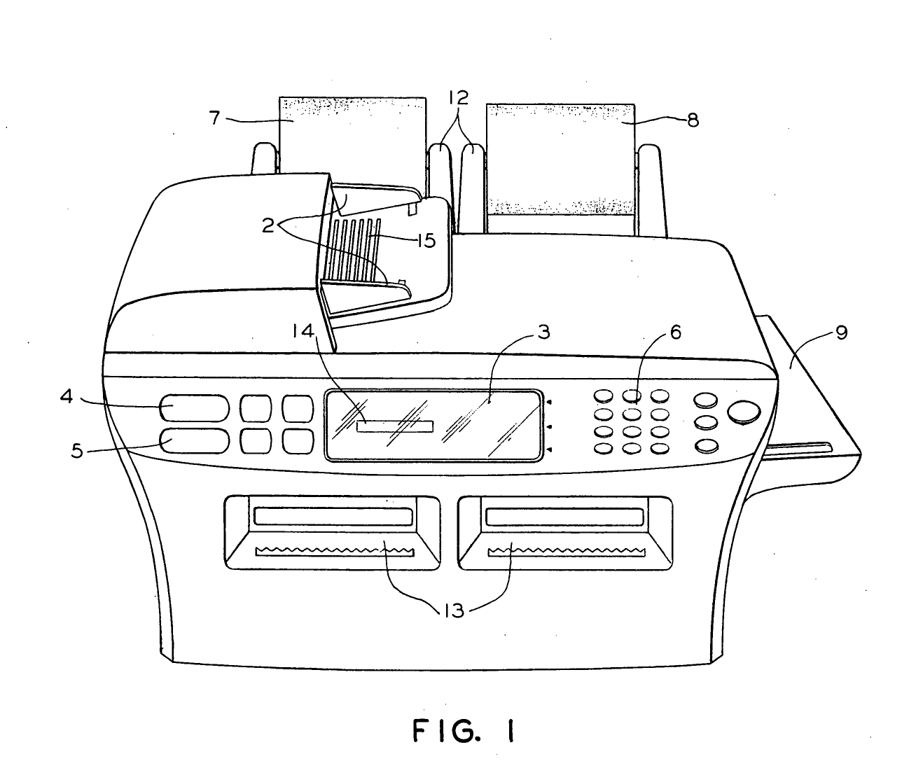

Reference is now made, more particularly, to FIG. 1 a checks are queued at the entrance of the check scanner and by placing the checks on tray 1 and aligning adjustable members 2. The checks are transported to a predetermined location within the apparatus (not shown) where the checks are scanned. The scanned check is advanced through the scanner and are deposited on tray 9

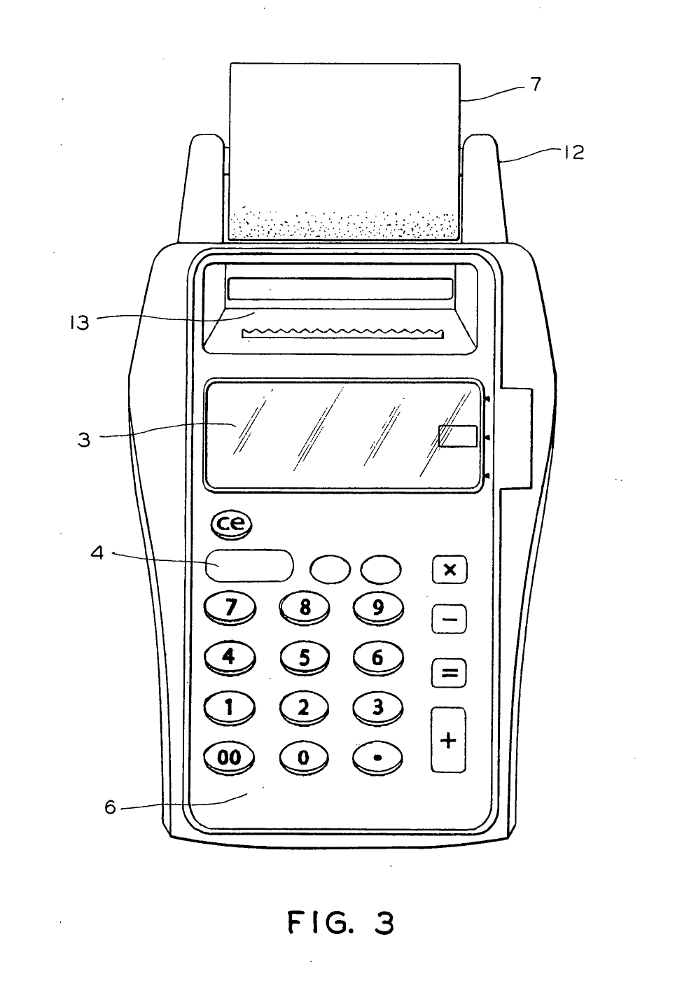

As illustrated in FIG. 3, the queued checks 100 are scanned 110 to produce digitized information. The scanner may be optical or optical and magnetic scanner (not shown). The digitized information is processed to capture the check information includes the bank on which the checks are drawn and the amount of the check. The check information is stored on a data storage media (not shown) and the information is processed 120 to calculate the deposit balance and item count. The check information, balance and item are preferably displayed 130 on preferably a liquid crystal display 3. Other displays such as light emitting diodes or cathode ray tubes are usable. Other information such as the date and time are also displayable. An input device preferably a keyboard 6 is used to correct 145 any errors in the check information. The entry reviewed is preferably highlighted 14 and the data is validated. The user then issues a print command 140. In the preferred embodiment the input device is a membrane switch. A depressible mechanical switch or touch screen are also usable. In the preferred embodiment, the user can selectively print deposit ticket or the check information and balance by actuating deposit ticket switch 4 or balance switch 5.

On actuating switch 4 or 5, the switch is operably connected to a second process 150, which can utilize the same processor as the calculating processor, is operably connected to the first process. The second process 150 formats the check information, deposit balance, sub-balance and item count to print deposit tickets that are arranged according to the conventional format.

The printer (not shown) is operably connected to the second process and the membrane switches 4 and 5. Pre-printed deposit tickets 7, preferably using multi layer no carbon required paper 10. Preferably the deposit tickets 7 have a perforation 11. Also available is blank paper 8 for selectively printing check information and deposit balance on actuation of switch 5. Deposit tickets 7 and blank paper 8 are held by a paper holders 12 and are transported through the printer, the information is printed 160 a predetermined location and advances, emerging at ports 13.

Another embodiment (not shown) of the invention separates the scanning and printing process from the information processing and manual input processes. A personal computer to receives the scanned check information, stores the information, calculates the deposit balance and item count and displays the information on a computer monitor (not shown). The computer monitor can be a liquid crystal display or cathode ray tube. The corrected data is inputted with a computer keyboard (not shown). Check information is validated by user and a print command is issued by the user with a computer keyboard (not shown). The processor formats the data to be printed on a deposit ticket. A printer of the type previously described prints the deposit tickets or check information and balance.

Another embodiment of the invention is illustrated in FIG. 3. The check information is entered using key board 6 and is processed to calculate the deposit balance and item count preferably displayed on liquid crystal display 3. The information is corrected using the keyboard 6. When the data is validated by the user, the print command is issued preferably by depressing a button switch 4. The printed deposit tickets 7 are previously described and are held on a holder 12. The deposit tickets are advanced and exit at port 13.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A check processing apparatus and deposit ticket printing system comprising:
(a) a check document take up and transport means wherein said document take up and transport means selectively takes each of such checks, transport each of such checks to a predetermined location, pauses for a predetermined interval and transports such check to exit such apparatus;
(b) a document scanning means at said predetermined location wherein such check is scanned and digitized;
(c) a scanning means operably connected to said document scanning means where said scanned digitized check is processed to capture bank identification and check amount information;
(d) a first processing means operably connected to said scanning means wherein said check amount information is received, stored and a balance and count of the number of such checks is calculated;
(e) a first output means, operably connected to said first processing means, at first predetermined location displaying check information, deposit balance and item count;
(f) a first input means positioned at second predetermined location and operably connected to said first processing means, to correct said check information;
(g) a second processing means to format said bank and check information in a form compatible with conventional deposit tickets, operably connected to said first processing means;
(h) a second input means to issue a command to said first and second processing means to validate and output said check information, deposit subtotals, and item count for each deposit ticket; and
(i) a second output means to print formatted said bank and check information, operably connected to said second processing means wherein said output device includes a paper holder transporter to print each deposit ticket and advance such ticket.

2. A check processing apparatus and deposit ticket printing system according to claim 1 wherein said scanning means is an optical scanner;

3. A check processing apparatus and deposit ticket printing system according to claim 1 wherein said scanning means is an optical and magnetic scanner;

4. A check processing apparatus and deposit ticket printing system according to claim 1 wherein said first processing means is optical character reading software;

5. A check processing apparatus and deposit ticket printing system according to claim 1 wherein said first input means is a keypad.

6. A check processing apparatus and deposit ticket printing system according to claim 5 wherein said keypad is one of a depressible key, membrane switch or touch screen.

7. A check processing apparatus and deposit ticket printing system according to claim 1 wherein said first output means is one of light emitting diode, cathode ray tube and liquid crystal display.

8. A check processing apparatus and deposit ticket printing system according to claim 1 wherein said second input means includes a command to selectively print deposit tickets and check amounts and said deposit balance separately.

9. A check processing apparatus and deposit ticket printing system according to claim 1 wherein said a check document take up and transport means, said document scanning means, said scanning means, said first processing means, said first output means, said a first input means, said second processing means; said second input means and said second output means are positioned within a single housing.

10. A check processing apparatus and deposit ticket printing system according to claim 1 wherein the first input means, second input means are a personal computer keyboard, first processing means and second processing means is a personal computer, said first output means is a computer monitor, said second output means is a check deposit ticket printer.

11. A check processing apparatus and deposit ticket printing system according to claim 10 where in said check document take up and transport means, said document scanning means and second output means are housed in a single housing operably connected to said personal computer.

12. A check processing and deposit ticket printing system comprising:
(a) a first input means to manually enter check information and corrected check information;
(b) a first processing means to receive and store said check information, calculate a deposit balance, and item count, operably connected to said first input means;
(c) an first output means operably connect to said processing means, to display said check amount information, deposit balance and item count;
(d) a second processing means to format said check information, and deposit balance and item count for such deposit ticket operably connected to said first processing means;
(e) a second input means to issue a command operably connected to said first and second processing means to validate and output said check information, and deposit balance and item count;
(d) a second output means to print deposit tickets operably connected to said format processing means.
(e) a paper holding and advancing means operably connected to said format processing means, wherein said paper holding and transport means advances such paper to a predetermine location for printing and advancing such paper.

13. A deposit ticket printing system according to claim 13 wherein said output means is one of light emitting diodes and liquid crystal display.
